(19) United States
(12) Patent Application Publication
(10) Pub. No.: US 2006/0133351 A1
(43) Pub. Date: Jun. 22, 2006

(54) Integrated access device

(75) Inventor: Lars Adolfsson, Tyreso (SE)

Correspondence Address: NIXON & VANDERHYE, PC, 901 NORTH GLEBE ROAD, 11TH FLOOR, ARLINGTON, VA, 22203, US

(73) Assignee: B2 Bredband AB, Stockholm (SE)

(21) Appl. No.: 11/024,040

(22) Filed: Dec. 29, 2004

(30) Foreign Application Priority Data
Dec. 22, 2004 (SE) 0403124-1

(51) Int. Cl. H04L 12/66

(52) U.S. Cl. 370/352; 370/401

(57) ABSTRACT

This invention regards an integrated access device (10) and a method therefore, comprising seamless PSTN to voice over Internet telephony. The access device (10) thus comprises a splitter (12, 32) having a filter filtering out data traffic from a digital subscriber line to the access device (10), allowing PSTN signals to pass through. It further comprises at least two ports (28) for connection of two telephone devices (38, 40), wiring the pair of wires (22) from one of the telephone ports to a pair of PSTN wires of a LAN port (26) receiving incoming PSTN and DSL signals, thus providing exclusion of rewiring in an external splitter (12) and that one of the telephone ports can be utilized booth for Internet voice and PSTN telephony.

### TECHNICAL FIELD

The present invention pertains to an integrated access device comprising seamless PSTN to voice over Internet telephony excluding rewiring in an external splitter, and a method therefore.

### BACKGROUND ART

Currently, if a home network customer purchases an integrated access device (IAD) that combines digital subscriber line equipment and services (xDSL) where x indicates a generic number of DSL, including for instance ADSL, HDSL, IDSL and VDSL with a voice over Internet (VoIP) account, the customer has to redo the cabling due to the fact that the port feeding the VoIP signal cannot be inserted back into the existing customer home network.

The current situation for the IAD is that the incoming xDSL traffic is stripped from public switched telephone network (PSTN) in an external splitter/splitter box and fed through a wide area network (WAN) port. The analog VoIP signal is fed on one of the registered jacks RJ-11 phone ports.

In order to feed the PSTN to the customer an external splitter is used. This causes the customer to redo cabling as the customer buys the VoIP, since the phones are effectively connected via the splitter. The wiring/cabling in the splitter box must be performed by a skilled service technician. Although the wiring installation is performed by a technician it has turned out that many of those installations are poor causing the xDSL service being affected, due to a worse signal environment.

The company PARADYNE® is one of a plurality of manufactures of IAD devices and its accessories. Their homepage www.paradyne.com provides the installation instructions of for instance the splitter box SuperLine™ 5030 POTS splitter (POTS, Plain Old Telephone Service).

### SUMMARY OF THE INVENTION

The present invention aims to solve problems relating to rewiring in splitter boxes and to provide a seamless transition from PSTN to VoIP and vice versa. This is accomplished through an integrated access device performing seamless PSTN to voice over Internet telephony. The access device comprises:

a splitter having a filter filtering out data traffic from a digital subscriber line to the access device, allowing public switched telephone network signals to pass through; and

at least two telephone ports for connection of voice over Internet telephony devices, wiring a pair of wires from one of the telephone ports to a pair of public switched telephone network wires of a network port receiving incoming public switched telephone network and DSL signals, thus providing that one of the telephone ports and the network port can be utilized for connecting public switched telephone network telephony.

One embodiment of the present invention comprises that a switch is connected to the filter device and the switch splitting the wiring from one of the pair of public switched telephone network wires for switching the filtered public switched telephone network signals from the filter to a telephone line for voice over Internet telephony.

Another embodiment comprises that the switch is set to switch between one of the ports, thereby directing public switched telephony to the port by setting a software parameter, the parameter controlling the electronics utilized for switching.

A further embodiment comprises that a signal on the pair of public switched telephone network wires is fed via the splitter to one of the telephones.

A still further embodiment comprises that a signal on the pair of public switched telephone network wires is fed to the voice over Internet circuit on one of the telephones.

Yet another embodiment comprises that it provides through the switch that one of the telephone ports can be utilized both for voice over Internet and public switched telephone network telephony.

Yet a still further embodiment comprises that the switch is set to switch between public switched telephone network and voice over the Internet by setting a software parameter, the parameter controlling the electronics utilized for switching.

Moreover, the present invention sets forth a method in an integrated access device performing seamless PSTN to voice over Internet telephony. The method comprises the steps of:

from a splitter having a filter filtering out data traffic from a digital subscriber line to the access device, allowing public switched telephone network signals to pass through; and

the access device having at least two telephone ports for connection of voice over Internet telephony devices, wiring a pair of wires from one of the telephone ports to a pair of public switched telephone network wires of a network port receiving incoming public switched telephone network and DSL signals, thus providing that one of the telephone ports and the network port can be utilized for connecting public switched telephone network telephony.

Furthermore, the method of the present invention sets forth embodiments described above in accordance with the attached set of dependent method claims.

### BRIEF DESCRIPTION OF THE DRAWINGS

Henceforth, the present invention makes reference to the accompanying drawings for a better understanding of its given embodiments and examples, wherein:

FIG. 1 schematically illustrates a prior art IAD with an external splitter;

FIG. 2 schematically illustrates an IAD in accordance with the present invention; and

FIG. 3 schematically illustrates an embodiment of a switch utilized to provide seamless telephony in accordance with the present invention.

### DETAILED DESCRIPTION OF PREFERRED EMBODIMENTS

A customer that for instance for the first time subscribes to services in a broadband network is connected via xDSL and is provided an IAD. The customer then utilizes telephones connected to the residential PSTN network jack. For services conveyed through a broadband network as for instance xDSL traffic introducing VoIP telephony an external splitter filters out the xDSL and a rewiring distributes the PSTN signals to the common network jack for PSTN telephony. As explained before the rewiring is complicated and often distorts or worsens the signal quality. Hence, the present invention introduces seamless telephony. The term seamless implies that the customer does not have to accomplish anything when connecting to for instance xDSL services. As frequently mentioned, a problem that is currently encountered in prior art is that the customer has to change the cabling in order to be able to use the broadband technology. During that process it is not unlikely that the xDSL service is affected due to a worse signal environment.

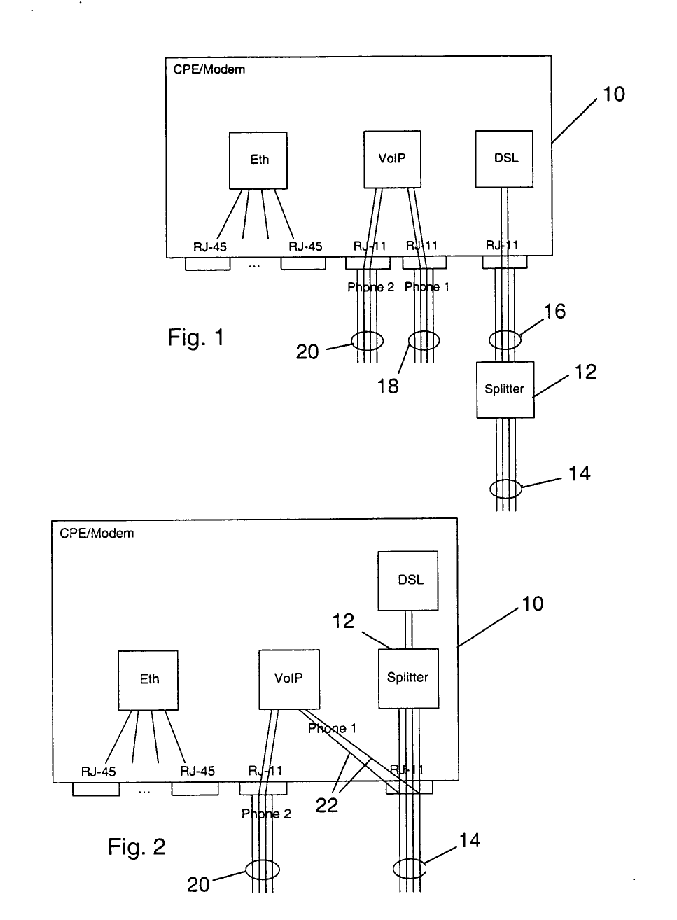

FIG. 1 schematically illustrates a prior art IAD 10 with an external splitter 12. Currently, if a customer purchases an IAD 10 that combines xDSL with a VoIP account, the customer needs to redo the cabling due to the fact that the port feeding the VoIP signal cannot be inserted back into the existing home PSTN network.

The wiring of incoming traffic is depicted through reference numeral 14, two copper pairs, inner pair DSL+PSTN, outer pair PSTN, whereby DSL is stripped from PSTN in the external splitter 12 and fed through the WAN port, rightmost RJ-11 in FIG. 1, i.e., the signal traffic on the two copper pairs 16 are input to the IAD 10, whereby the two inner pairs are conveying DSL, but the PSTN signals are splitt meaning that the outer pair is not in use. The analog VoIP signal is fed on the Phone 1 or Phone 2 RJ-11 ports. From the two phone ports phone 1 and phone 2 are each two cooper pairs 18 (phone 1) and 20 (phone 2), respectively connected as outputs of the IAD or inputs two the phones. Each inner copper pair carries analog telephony from the VoIP/SIP circuit (SIP, Session Initiation Protocol), and each outer pair is not in use.

Furthermore, there are four RJ-45 ports, numbered 1-4 (not shown) at the left of the figure, which are denoted as LAN ports communicating via Ethernet (Eth). It is appreciate that the four LAN ports are given as an example; other IAD may have different numbers of ports. Hence, FIG. 1 illustrates a common schematic prior art hardware model for an IAD 10, where the splitter 12 is external to the IAD.

The present invention sets forth an IAD 10 hardware model with a splitter comprised within the IAD 10 in order to exclude re-cabling to provide PSTN telephony in a customer's premise, which is schematically illustrated in FIG. 2.

The Splitter 12 is now internal in the IAD 10, and the Phone 1 port can, in one embodiment of the present invention, be removed as shown in FIG. 1, where the outer pair 22 from the VoIP circuit has been connected to the outer pair in wire bundle 14 carrying the PSTN signals to the WAN port, rightmost RJ-11 port in FIG. 2. The Phone 2 port operates as previously in prior art. It is now appreciated that the analog signal on the outer pair 14 in the WAN port can now be fed either via a) the splitter or b) the VoIP/Phone 1 circuit. Hence, the present invention IAD provides a simple installation of broadband and keeping the PSTN intact, thus excluding recabling to connect the PSTN to the existing PSTN home network. Furthermore, with a switch, phone 1 in this embodiment could be utilized both for PSTN telephony and voice over Internet telephony, and phone 2 for instance to plug in a telephone headset.

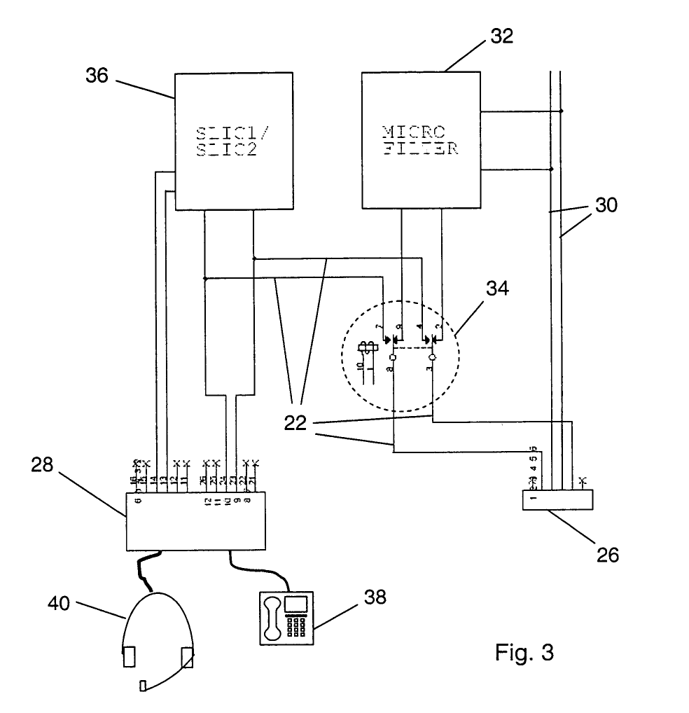

FIG. 3 schematically illustrates an embodiment of a switch 34 utilized to provide seamless telephony in accordance with the present invention. Reference numeral 30 depicts the incoming DSL wire pair on WAN port 26 in the IAD, 10 and the micro filter 32 acts as an internal IAD 10 splitter. The outer pair of wires 22 that where wired/drawn from the phone 1 port, comprised in connector 28, to the outer pair of the WAN port to convey PSTN signals is now split by a switch connected to the splitter 32 filtering out the PSTN signals and feeding them to either the WAN port 26 or to the phone 1 port comprised in connector 28. Also, depicted in FIG. 3 are the subscriber line interface circuits 36 for phone 1 and phone 2, SLIC1 and SLIC2, respectively, which feed VoIP signals to phone port 1 and 2 both comprised in the connector 28.

Moreover, FIG. 3 depicts a telephone device 38 connected to phone port 1, thus enabling both PSTN and VoIP telephony through one telephone set 38 depending on how the switch 34 is controlled, which should be obvious for a person skilled in the art. One embodiment of the present invention comprises that the switch 34 is set to switch between public switch telephone network and voice over the Internet on the phone 1 port in connector 28 by setting a software parameter, the parameter is then controlling the electronics utilized for switching. Another embodiment comprises that the switch 34 is controlled by voltage on the public switch telephone network line or absence of voltage.

Hence, the IAD 10 of the present invention is provided a splitter 12, 32, having a filter filtering out data traffic from a digital subscriber line to the IAD 10, allowing public switched telephone network signals to pass through. Moreover, it is provided at least two telephone ports 28, depicted as comprised in a connector in FIG. 3, for connection of voice over Internet telephony devices 38, 40. A pair of wires 22 are wired/drawn from one of the telephone ports to a pair of public switched telephone network wires of a network port 26 receiving incoming public switched telephone network and DSL signals, thus providing that one of the telephone ports 28 and the network port 26 can be utilized for connecting public switched telephone network telephony.

It is to be understood that the phone ports 1 and 2 in connector 28 not necessarily are connected to telephony devices 38, 40, but also being directly connected to networks for PSTN and VoIP telephony.

Reference numeral 40 depicts a headset utilized for VoIP telephony.

It is appreciated that the attached set of claims defines further embodiments of the present invention to a person skilled in the art.

1. An integrated access device performing seamless public switched telephone network to voice over Internet telephony, characterized by comprising:
a splitter having a filter filtering out data traffic from a digital subscriber line to said access device, allowing public switched telephone network signals to pass through; and
at least two telephone ports for connection of voice over Internet telephony devices, wiring a pair of wires from one of said telephone ports to a pair of public switched telephone network wires of a network port receiving incoming public switched telephone network and DSL signals, thus providing that one of said telephone ports and said network port (26) can be utilized for connecting public switched telephone network telephony.

2. An access device according to claim 1, characterized in that a switch is connected to said filter device and said switch splitting said wiring from one of said pair of public switched telephone network wires for switching said filtered public switched telephone network signals from said filter to a telephone line for voice over Internet telephony.

3. An access device according to claim 2, characterized in that said switch is set to switch between one of said ports, thereby directing public switched telephony to said port by setting a software parameter, said parameter controlling the electronics utilized for switching.

4. An access device according to claim 1, characterized in that a signal on the pair of public switched telephone network wires is fed via said splitter to one of said telephones.

5. An access device according to claim 1, characterized in that a signal on the pair of public switched telephone network wires is fed to the voice over Internet circuit on one of said telephones.

6. An access device according to claim 2, characterized in that it provides through said switch (34) that one of said telephone ports can be utilized both for voice over Internet and public switched telephone network telephony.

7. An access device according to claim 6, characterized in that said switch is set to switch between public switched telephone network and voice over the Internet by setting a software parameter, said parameter controlling the electronics utilized for switching.

8. An access device according to claim 6, characterized in that said switch is controlled by voltage on the public switched telephone network line or absence of voltage.

9. A method in an integrated access device performing seamless public switched telephone network to voice over Internet telephony, characterized by comprising the steps of:
from a splitter having a filter filtering out data traffic from a digital subscriber line to said access device, allowing public switched telephone network signals to pass through; and
said access device having at least two telephone ports for connection of voice over Internet telephony devices, wiring a pair of wires from one of said telephone ports to a pair of public switched telephone network wires of a network port receiving incoming public switched telephone network and DSL signals, thus providing that one of said telephone ports and said network port can be utilized for connecting public switched telephone network telephony.

10. A method in an access device according to claim 9, characterized in connecting a switch to said filter device and said switch splitting said wiring from one of said pair of public switched telephone network wires for switching said filtered public switched telephone network signals from said filter to a telephone line for voice over Internet telephony.

11. A method in an access device according to claim 10, characterized in that said switch is set to switch between one of said ports, thereby directing public switched telephony to said port by setting a software parameter, said parameter controlling the electronics utilized for switching.

12. A method in an access device according to claim 9, characterized in that a signal on the pair of public switched telephone network wires is fed via said splitter to one of said telephones.

13. A method in an access device according to claim 9, characterized in that a signal on the pair of public switched telephone network wires is fed to the voice over Internet circuit on one of said telephones.

14. A method in an access device according to claim 10, characterized in that it provides through said switch that one of said telephone ports can be utilized both for voice over Internet and public switched telephone network telephony.

15. A method in an access device according to claim 14, characterized in that said switch is set to switch between public switched telephone network and voice over the Internet by setting a software parameter, said parameter controlling the electronics utilized for switching.

16. A method in an access device according to claim 14, characterized in that said switch is controlled by voltage on the public switched telephone network line or absence of voltage.
